(19) United States
(12) Patent Application Publication
(10) Pub. No.: US 2008/0310717 A1
(43) Pub. Date: Dec. 18, 2008

(54) Apparatus and Method for Image Labeling

(75) Inventors: Carsten Saathoff, Rhineland-Palatinate (DE); Steffen Staab, Rhineland-Palatinate (DE)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/160,448

(22) PCT Filed: Jan. 29, 2007
(86) PCT No.: PCT/US07/61226

§ 371 Date: Jul. 10, 2008

(30) Foreign Application Priority Data
Feb. 1, 2006 (GB) 0602019.2

(51) Int. Cl. G06K 9/34

(52) U.S. Cl. 382/173

(57) ABSTRACT

An apparatus for labelling images comprises a segmentation processor (103) which segments an image into image segments. A segment label processor (105) assigns segment labels to the image segments and a relation processor (107) determines segment relations for the image segments. A CRP model processor (109) generates a Constraint Reasoning Problem model which has variables corresponding to the image segments and constraints reflecting the image segment relations. Each variable of the model has a domain comprising image segment labels assigned to an image segment of the variable. A CRP processor (111) then generates image labelling for the image by solving the Constraint Reasoning Problem model. The invention may allow improved automated labelling of images.

### FIELD OF THE INVENTION

The invention relates to an apparatus and method for image labelling and in particular to image labelling based on image segmentation.

### BACKGROUND OF THE INVENTION

As images are increasingly stored, distributed and processed as digitally encoded images, the amount and variety of encoded images has increased substantially.

However, the increasing amount of image data has increased the need and desirability of automated and technical processing of pictures with no or less human input or involvement. For example, manual human analysis and indexing of images, such as photos, is frequently used when managing image collections. However, such operations are very cumbersome and time consuming in the human domain and there is a desire to increasingly perform such operations as automated or semi-automated processes in the technical domain.

Accordingly, algorithms for analyzing and indexing images have been developed. However, such algorithms tend to be restrictive and have a number of disadvantages including:
They focus on rather narrow image domains such as only images relating to a specific location (e.g. only to images of a beach, landscapes, faces etc)
They furthermore tend to need very specialized algorithms for low-level analysis.
They consider only very low-level analysis and disregard abstracting knowledge which is much more useful to the user.
The indexing tends to consider the image as a black box and does not elucidate what conceptual information is found in the picture (e.g. they do not allow answering of sophisticated questions such as “show me all images with people riding a horse” vs. just “show me all images with people and horses”)

Thus, current algorithms for indexing or labelling images tend to be inefficient and/or to result in suboptimal information being generated. Specifically, current methods tend to only consider low-level information and to ignore background knowledge in order to improve the performance.

For example, a known approach of image labelling comprises using low-level processes to segment the image into image segments and applying pattern recognition to each image segment. If a pattern is recognized for an image segment, the segment is then labelled by one or more labels which correspond to the detected pattern. For example, an image segment may be detected as a house and the segment may accordingly be labelled by the label “house”.

However, the approach typically results in a large number of small segments which are individually labelled. Furthermore, the labelling is disjoint, separate and possibly conflicting for the individual image segments. Furthermore, the labelling does not reflect any conceptual or global information for the image. Thus, the approach tends to result in a labelling which is suboptimal and which is difficult to use in managing and organizing images.

Hence, an improved image labelling would be advantageous and in particular image labelling allowing increased flexibility, additional or improved information, efficient implementation, improved image domain independence and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided

1. An apparatus for labelling images, the apparatus comprising:
means for segmenting an image into image segments;
assignment means for assigning segment labels to the image segments;
means for determining segment relations for the image segments;
model means for generating a Constraint Reasoning Problem model having variables corresponding to the image segments and constraints reflecting the image segment relations, each variable having a domain comprising image segment labels assigned to an image segment of the variable; and
means for generating image labelling for the image by solving the Constraint Reasoning Problem model.

The invention may allow an improved labelling of images. Improved information may be captured for an image and in particular information related to relationships between image segments and/or context information and/or conceptual information may be taken into account and/or may be reflected in the labelling.

The invention may allow an automated and/or semi-automated labelling of images reducing the manual time and effort required.

The invention may allow labelling data to be generated which is more suitable for searching, reasoning, selection and otherwise processing or managing images. A practical and efficient implementation may be achieved.

Specifically, in some embodiments the invention may allow analysis of an image which provides a conceptual index of image content based on low-level image processing and high-level domain understanding using a constraint reasoning system.

According to an optional feature of the invention, the image segment relations comprise spatial relations.

This may allow a particularly advantageous labelling and in particular may allow improved labelling data to be generated and/or an efficient and facilitated implementation.

According to an optional feature of the invention, the spatial relations comprise relative spatial relations.

This may allow a particularly advantageous labelling and in particular may allow improved labelling data to be generated and/or an efficient and facilitated implementation.

According to an optional feature of the invention, the spatial relations comprise absolute spatial relations.

This may allow a particularly advantageous labelling and in particular may allow improved labelling data to be generated and/or an efficient and facilitated implementation.

According to an optional feature of the invention, the model means is arranged to determine the constraints in response to the segment relations and image domain data.

The feature may allow improved image labelling. In particular, image labelling data reflecting non-local characteristics and/or image context information may be generated. The image domain data may be data reflecting an image content category for the image.

According to an optional feature of the invention, the assignment means is arranged to assign reliability indications for the segment labels.

This may allow improved image labelling and may in particular allow improved labelling data to be generated which is more advantageous for e.g. searching, reasoning, selection and otherwise processing or managing images.

According to an optional feature of the invention, the Constraint Reasoning Problem model is a fuzzy logic Constraint Reasoning Problem model.

This may allow improved image labelling and may in particular allow improved labelling data to be generated which is more advantageous for e.g. searching, reasoning, selection and otherwise processing or managing images.

A fuzzy logic Constraint Reasoning Problem model may be any Constraint Reasoning Problem model which allows non-binary decisions and/or non-binary satisfaction of constraints such as or constraints only being satisfied to some degree.

According to an optional feature of the invention, the apparatus further comprises merging means for merging segments in response to the image labelling.

This may allow improved image labelling and may in particular allow an improved identification and labelling of features and characteristics in the image.

According to an optional feature of the invention, segments are merged in response to an adjacency criterion.

This may allow improved performance and/or improved merging of segments and specifically may allow an improved accuracy of merging of image segments belonging to the same image object. The adjacency criterion may for example comprise a requirement that segments to be merged must be adjacent.

According to an optional feature of the invention, segments are merged in response to a segment labelling criterion.

This may allow improved performance and/or improved merging of segments and specifically may allow an improved accuracy of merging of image segments belonging to the same image object. The segment labelling criterion may for example comprise a requirement that segments to be merged must comprise at least one or more labels which are substantially identical.

According to an optional feature of the invention, the segment labelling criterion requires that all segments being merged have corresponding labels in all solutions of the Constraint Reasoning Problem model.

This may allow improved performance and/or improved merging of segments and specifically may allow an improved accuracy of merging of image segments belonging to the same image object.

According to an optional feature of the invention, the apparatus further comprises means for selecting between solutions of the Constraint Reasoning Problem model in response to a user input.

This may allow improved image labelling and may allow a semi-automated process with facilitated labelling while allowing human intervention.

According to an optional feature of the invention, the apparatus is arranged to iterate a labelling of an image.

This may allow improved image labelling.

According to an optional feature of the invention, the image labelling comprises one or more solutions to the Constraint Reasoning Problem model, each solution comprising a segment label for each segment selected from the domain of the segment.

This may allow improved image labelling and/or facilitated implementation.

According to another aspect of the invention, there is provided a method of labelling images, the method comprising: segmenting an image into image segments; assigning segment labels to the image segments; determining segment relations for the image segments; generating a Constraint Reasoning Problem model having variables corresponding to the image segments and constraints reflecting the image segment relations, each variable having a domain comprising image segment labels assigned to an image segment of the variable; and generating image labelling for the image by solving the Constraint Reasoning Problem model.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of an apparatus for labelling images in accordance with some embodiments of the invention;

FIG. 2 illustrates an example of a constraint satisfaction problem; and

FIG. 3 illustrates a method of labelling images in accordance with some embodiments of the invention.

### DETAILED DESCRIPTION OF SOME EMBODIMENTS OF THE INVENTION

The following description focuses on an apparatus for labelling digitally encoded images such as digital photos or digitally encoded video images.

The apparatus is arranged to segment an image to be labelled using low-level image processing algorithms. Each image segment is then categorized e.g. using existing image segment classifiers. The apparatus then uses relationships (and specifically spatial relationships) between the segments to transform the initially labelled image into a constraint satisfaction problem model and a constraint reasoner is then used to remove those labels that do not fit into the spatial context. The possible arrangements of concepts are defined as domain knowledge. The constraint reasoning model is well suited to incorporate other types of information as well, such as specialized algorithms or different types of segmentation and thus it can form a generic basis for incorporating knowledge into the image understanding process.

The apparatus is based on a reformulation of the problem of labelling image segments as a constraint reasoning approach which may also consider background knowledge for the domain, such as spatial orientation that is valid for a given domain. The approach may include segment merging to arrive at an improved image segmentation.

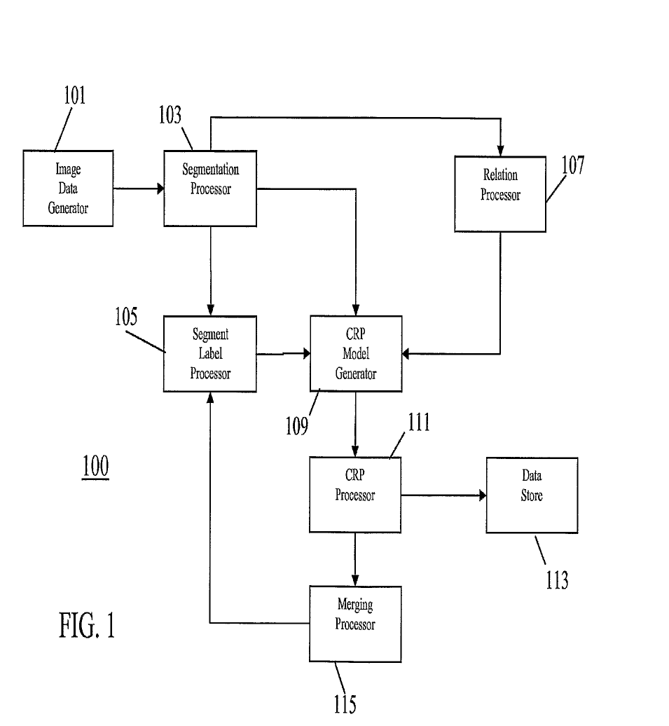

FIG. 1 illustrates an example of an apparatus for labelling images in accordance with some embodiments of the invention.

The apparatus 100 comprises an image data generator 101 which generates a digitally encoded picture. It will be appreciated that in different embodiments the image data generator 101 may for example comprise functionality for capturing, digitising and encoding a photo or video frame and/or for receiving a digitally encoded image or image sequence from an internal or external source. In some embodiments, the image data generator 101 may comprise or consist in a data storage for digital images.

The image data generator 101 is coupled to a segmentation processor 103 which receives the image to be labelled from the image data generator 101. The segmentation processor 103 segments the image into a number of image segments.

The segmentation into image segments is based on a low level analysis of the image and specifically the segmentation processor segments the image into image segments based on low level characteristics such as colour and motion.

The aim of image segmentation is to group pixels together into image segments which have similar characteristics, for example because they belong to the same object. A basic assumption is that object edges cause a sharp change of brightness or colour in the image. Pixels with similar brightness and/or colour are therefore grouped together resulting in brightness/colour edges between regions.

Specifically, image segmentation can comprise the process of a spatial grouping of pixels based on a common property. There exist several approaches to picture- and video segmentation, and the effectiveness of each will generally depend on the application. It will be appreciated that any known method or algorithm for segmentation of a picture may be used without detracting from the invention.

In some embodiments, the segmentation includes detecting disjoint regions of the image in response to a common characteristic and a tracking this object from one image or picture to the next.

For example, the segmentation can comprise grouping picture elements having similar brightness levels in the same image segment. Contiguous groups of picture elements having similar brightness levels tend to belong to the same underlying object. Similarly, contiguous groups of picture elements having similar colour levels also tend to belong to the same underlying object and the segmentation may alternatively or additionally comprise grouping picture elements having similar colours in the same segment.

Examples of image segmentation will be well known to the person skilled in the art and can for example be found in V. Mezaris, I. Kompatsiaris, and M. G. Strintzis. “A framework for the efficient segmentation of large-format color images”. In Proceedings of International Conference on Image Processing, volume 1, pages 761-764, September 2002, Rochester (NY).

The segmentation processor 103 is coupled to a segment label processor 105 which assigns segment labels to the individual image segments.

Specifically, the segment label processor 105 performs pattern recognition for the individual segments taking into account the domain of an image. The domain of an image corresponds to a set of parameters and characteristics which are common for the images belonging to that domain. As an example, an image domain may correspond to a beach domain i.e. it may have an image content corresponding to a visual image from a beach. For this domain, information may be known as the objects that can be expected to be found such as sea, sand, sun etc and relations may be known for the objects such as that the sun is above the sand. Other domains can for example correspond to other image contents such as faces, landscapes, people, sports etc.

The segment label processor 105 can thus perform a pattern recognition based on knowledge of the domain of the picture and can recognise segments corresponding to known patterns. One or more labels can be predetermined for each pattern and when the pattern recognition finds one or more matches, the labels corresponding to those matches are assigned to the image segment.

Various algorithms and methods of pattern recognition and assigning labels to image segments will be known to the person skilled in the art. Such examples can for example be found in K. Petridis, F. Precioso, T. Athanasiadis, Y. Avrithis and I. Kompatsiaris: “Combined Domain Specific and Multimedia Ontologies for Image Understanding”, Workshop on Mixed-reality as a Challenge to Image Understanding and Artificial Intelligence at the 28th German Conference on Artificial Intelligence, KI 2005, Koblenz, Germany, September 2005.

As a specific example of an algorithm for assigning a label, the segment label processor 105 can be trained with a set of examples. Such examples can consist of the label and a number of low-level characteristics, such as colour or shape characteristics, describing how the label is typically represented in a digital image. The examples are used to train a classifier, which can be used to predict the label of a given region by comparing the distance between the examples and the low-level characteristics found in the segment.

The segmentation processor 103 is furthermore coupled to a relation processor 107 which is arranged to determine segment relations for the image. In the example of FIG. 1, the relations are spatial relations between the image segments such as an indication of whether one image segment is in front of, behind, left of, right of, below or above another image segment.

Algorithms for determining such relations are well known in the art and can for example be based on occlusion and movement data for the objects corresponding to the image segments. As a specific example, relations can be generated based on the angle between the bounding boxes of two segments. A bounding box is the smallest possible rectangular containing the segment. Then, the angle between a horizontal line through the centre of one box and the line connecting both centres is computed. For instance, having an angle around 90 degrees would indicate that one segment is above the other, if the segments are disjoint.

The segmentation processor 103, the segment label processor 105 and the relation processor 107 are all coupled to a CRP model generator 109. The CRP model generator 109 is arranged to generate a Constraint Reasoning Problem (CRP) model for the image with the variables corresponding to the image segments, constraints reflecting the image segment relations and each variable having a domain comprising the image segment labels assigned to the image segment of the variable.

The CRP model generator 109 is coupled to a CRP processor 111 which is arranged to solve the CRP model. A CRP processor 111 is coupled to a data store 113 in which the solution to the CRP model is stored. The CRP model specifically contains a labelling of the segments of the image which reflects domain information and inter-segment information. Specifically, the solution can remove all label assignments of the segment label processor 105 which are not consistent with labelling of other segments and the relations with these. Thus, the solution can comprise none, one or more segment labels for each image segment selected from the variable domain of that segment, such that the selection is compatible with the selection for other image segments and the constraints between them.

Thus, in the example, the CRP model generator 109 is fed a segmentation mask with one or more possible labels assigned to each of the image segments as well as the spatial relations between the image segments. Although the produced image segments does have some semantic information, i.e. the set of initial labels, further processing to provide further information that is more in line with human perception is desirable.

To accomplish this, the limitations posed by the numerically based segmentation algorithms should be addressed. For example:
In the real world, objects are not usually homogenous but tend to consist of parts with differing visual features. As a result, the produced segmentation masks tend to fail to capture the depicted objects as single segments. Instead, a set of segments is produced for a single object, corresponding to its constituent parts in the ideal case. In practice this means that from the set of possible labels assigned to each segment, the ones that lead to the formation of an object in compliance with the domain knowledge should be favoured.
The transition from the three-dimensional space to the two-dimensional image plane results in loss of one of the fundamental real-world objects properties, namely their connectivity. As a consequence, appropriate handling is required to ensure that object connectivity is preserved at the semantic descriptions level. Loss of connectivity can result from e.g. occlusion phenomena or over-segmentation because of uneven visual features. For example, a region corresponding in reality to the concept sky might appear as a set of segments, either adjacent or not, because of colour variations, the existence of clouds, the existence of an airplane etc. It can easily be seen that topological and contextual information in terms of neighbouring region's semantics plays an important role for such reasoning.
The visual features alone do not always provide adequate criteria for the discrimination of semantic concepts with similar visual characteristics. Additionally, the same objects may have different visual features under different contexts, i.e. the colour of the sky varies significantly depending on whether it is a night or day scene, the weather conditions are cloudy or sunny, etc. In such cases intelligence exploiting contextual and spatial information is required in order to decide the correct label given the initial set of possible labels.

In the example of FIG. 1, the solution by the CRP processor 111 of the CRP model generated by the CRP model generator 109 allows an improved labelling to be generated which addresses these issues. This allows a more accurate automated labelling of images in the technical domain and allows the generation of characteristics and information more in line with human perception.

A constraint satisfaction problem consists of a set of variables and a set of constraints. A variable is defined by its domain, i.e. the set of values that are legal assignments for this variable. The constraints relate several variables to each other and define which assignments for each one of them is allowed considering the assignments of the related variables. Constraint satisfaction problems can be represented as graphs where variables are treated as nodes labelled with their domain and constraints are treated as edges labelled with the constraint between the involved nodes.

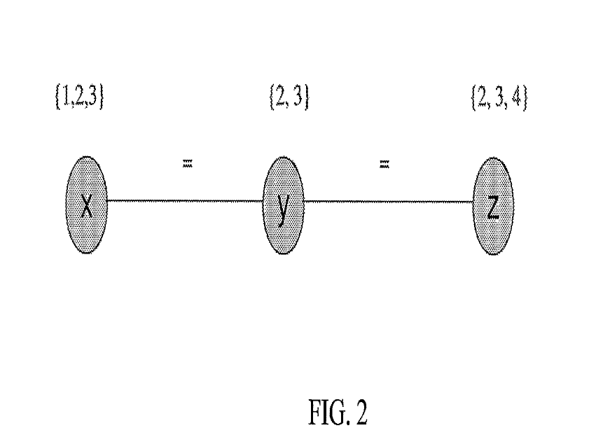

FIG. 2 illustrates an example of a very simple constraint satisfaction problem. In the example, the constraint satisfaction problem consists of three variables x, y and z, and two constraints x=y and y=z, i.e. all three variables must be equal.

Constraint satisfaction problems are not limited to finite domains but can also be applied to infinite domains. In this case the domains are normally given as intervals and the constraint reasoner reduces those intervals such that only numbers/intervals which are present in a solution to the constraint satisfaction problem are included.

For example, a CSP with two variables x and y, where the domain of x is [0,20] and the domain of y is [10,20], and the constraint x>y, would yield a domain reduction for x to the interval [10,20].

A formal definition of a constraint satisfaction problem, based on Apt, Krzystof R. “Principles of Constraint Programming”, Cambridge University Press, 2003, consists of a set of variables V={v₁, . . . , vₙ} and a set of constraints C={c₁, . . . , cₙ}. Each variable vᵢ has an associated domain D(vᵢ)={l₁, . . . , lₙ} which contains all values that can be assigned to vᵢ. Each constraint cⱼ is defined on a subset {vₓ₁, . . . , vₓₗ} where x1, . . . xl is a subsequence of 1, . . . , n. A constraint cⱼ is defined as a subset of the cross product of the domains of the related variables, i.e. cⱼ is a subset of D(vₓₗ)x . . . x D(vₓₗ). The constraint is said to be solved, if both cⱼ=D(vₓₗ)x . . . xD(vₓₗ) and cᵢ are non-empty. A constraint reasoning problem is solved if both all of its constraints are solved and no domain is empty, and failed if it contains either an empty domain or an empty constraint

In the system of FIG. 1, the labelled image segments and the corresponding spatial relations are transformed into a constraint satisfaction problem by the CRP model generator 109.

The segmented image and the spatial relations between the different segments are directly transformed into a constraint satisfaction problem by instantiating a variable for each segment and adding a corresponding constraint for each spatial relation between two segments. The hypotheses sets (i.e. the labels assigned by the segment label processor 105) become the domains of the variables so that the resulting constraint satisfaction problem is a finite domain constraint satisfaction problem.

Two types of spatial constraints can be distinguished: relative and absolute. Relative spatial constraints are derived from spatial relations that describe the relative position of one segment with respect to another one, like left-of or above-of. These are obviously binary constraints. Absolute spatial constraints are derived from the absolute positions of segments on the image, like above-all, which describes that a segment is on the top of the image. These are unary constraints.

The segmented image and the spatial relations between the different segments are directly transformed into a constraint satisfaction problem by instantiating a variable for each segment and adding a corresponding constraint for each spatial relation between two segments. The constraints are in the example defined as so-called good-lists, i.e. lists containing the tuples of labels that are permitted for the constraint. For example, the constraint left-of can be defined as left-of={(sea, sea), (sand, sand), (sea, sand), . . . } indicating that a sea object is allowed left of another sea object, a sand object is allowed left of another sand object etc.

This approach is slightly different compared to a traditional constraint definition. Traditional constraints are defined based on the variable domains and are constraint satisfaction problem specific. In contrast, the constraints of the CRP model generator 109 are part of the domain knowledge and thus are independent of a specific constraint satisfaction problem generated from an image. Accordingly, the notion of a satisfied constraint is adjusted accordingly.

Specifically, the steps for transforming the labelled image are as follows:
1. For each segment sᵢ of the image create a variable vᵢ.
2. Let ls(sᵢ) be the label set of the segment, then set the domain of vᵢ to D(vᵢ)=ls(sᵢ).
3. For each absolute spatial relation rⱼ of type T on a segment sᵢ create a unary constraint CT (vⱼ) on the variable vⱼ.
4. For each relative spatial relation cⱼ of type T between two segments sₖ and sᵢ create a binary constraint CT (vₖ, vᵢ) on the variables vₖ and vᵢ.

We now call a constraint C on a set of variables V={v₁, . . . , vₙ} satisfied if for each assignment to a variable νᵢ=V, assignments to the other variables exist that are legal with respect to the constraint. As all domains are finite, a finite-domain constraint satisfaction problem is created. This means, all solutions can be computed, i.e. each possible and legal labelling for the image. This can be of value after the solution, e.g. to enable the user to choose the labelling that best fits his expectations or to propose mergings based on the specific solutions.

It will be appreciated that any specific method or algorithm for solving the constraint reasoning problem model by the CRP processor 111 can be used. An example of an algorithm for solving a constraint satisfaction problem can for example be found in Apt, Krzystof R. “Principles of Constraint Programming”, Cambridge University Press, 2003.

The apparatus of FIG. 1 thus provides an improved labelling of images which may include and represent additional information. The generated labelling information may have improved internal consistency and reflect non-local image characteristics. Furthermore, the generated information may provide information which is more suitable for further processing and specifically for further reasoning. Additionally, because the system also detects the region a concept is depicted in, it allows e.g. an answer to be generated to more complex queries, such as a request for images where the sea is above the beach as opposed to a request merely for images containing beach and sea. Also, the approach is relatively domain independent and is not dependant on specialized algorithms.

The above description focuses on a constraint reasoning problem which uses binary constraints and absolute reasoning. However, in some embodiments a fuzzy logic constraint reasoning problem model can be used. Specifically, reliability indications can be assigned to the segment labels by the segment label processor 105. The reliability indications can be determined by the pattern recognition process and can reflect the closeness of the match between the individual image segment and the matching pattern.

The constraint reasoning problem model can then be developed to reflect the reliability indications of the labels as well as the non-binary constraints, and the CRP processor 111 can solve the constraint reasoning problem using non-binary decisions.

In the example of FIG. 1, the apparatus furthermore comprises an optional merging processor 115 which is arranged to merge image segments in response to the image labelling.

The image segments generated by the segmentation processor 103 will typically be segmented to a degree wherein multiple segments often belong to the same underlying image object and the merging processor 115 seeks to combine these image segments into a single image segment representing the image object.

Thus, the segmentation processor 103 may initially perform an over-segmentation that is then reduced by the merging processor 115 which seeks to combine segments that belong to the same semantic concept.

When a coarse segmentation is applied, small objects tend to be fused into bigger ones, e.g. a small region depicting an airplane will be fused with the dominant region of sky. However, using an over-segmented image has the drawback of segmenting a single object into more than one image segment. For example, the sea often contains regions with varying light intensity depending on the exposure and other factors such as the depth of the sea. After the CRP processor 111 has reduced the initial label hypotheses set of the segment label processor 105, the spatial context can be exploited by the merging processor 115 in order to merge regions that belong together.

The merging of different regions into a combined region can be performed based on a segment labelling criterion (such as a criterion that the same labels must be included) and/or an adjacency criterion (such as a criterion that all segments must be adjacent before merging is allowed). Specifically, the merging processor 115 of FIG. 1 requires that all segments that are merged have corresponding labels in all solutions of the Constraint Reasoning Problem model. Thus, in order to be merged, two segments must have the same label in the solutions to the constraint reasoning problem although these may be different from one solution to another. It will be appreciated that other criteria may additionally or alternatively be used.

In more detail, the exemplary merging processor 115 uses a simple rule defined as:
Two segments can be merged if they are adjacent and contain the same unique label.

In this case adjacent is taken as shorthand for the concrete spatial relations used in the specific implementation, i.e. left-of, right-of, above-of and below-of. So basically for each spatial relation that models adjacency, a dedicated rule is defined. Such a rule is part of the domain knowledge and thus can be modelled in a generic way.

A rule based reasoning approach is typically well suited for the merging process. However if the rule is formulated as e.g.:

segment(x),segment(y),left-of(x,y),label(x,l),label(y,l)->merge(x,y)

(i.e. that segment x and y can be merged if x is left of y and the labels of the solution are identical), this is also met for e.g. the segments:

ls(x)={sea,sand} and ls(y)={sea}.

In other words, it is sufficient for the rule to be met that the segments contain the same label. However, if the segments also contain other labels that are not compatible, the merging should not be performed despite the above rule being met.

Therefore, the rule used preferably reflects the knowledge that two segments are only supposed to be merged, if this is legal in every solution, i.e. if the labels are the same for all solutions. E.g. for two segments x,y which are related by the spatial relationship left-of and which have the label sets ls(x)={sky,sea} and ls(y)={sky,sea}, there are only two solutions to this constraint: x=sky, y=sky and x=sea,y=sea. Whatever the final labelling will be, the segments can be merged as they obviously belong to the same homogenous region—thus for both solutions to the constraint reasoning problem the label is the same.

In some embodiments, the apparatus is arranged to iterate the process. Thus, after the merging by the merging processor 115, the image is fed back to the Segmentation Processor 103 and the CRP model generator which modifies the constraint reasoning problem model such that it is based on the new combined segments. Specifically, the variables are defined as the segments of the image after merging and the constraints and domains are modified accordingly. The resulting constraint reasoning problem is then solved. The process may e.g. be iterated a fixed number of times or until a convergence criterion is met (e.g. that label variations or segment merging falls below a predetermined threshold).

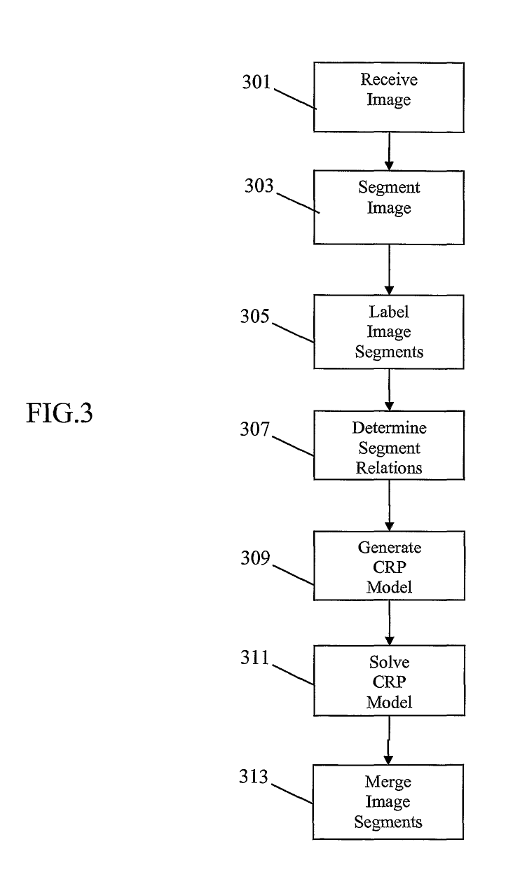

FIG. 3 illustrates a method of labelling images in accordance with some embodiments of the invention. The method may be executed by the apparatus of FIG. 1 and will be described with reference thereto.

In step 301 the image data generator 101 receives the image to be labelled.

Step 301 is followed by step 303 wherein the segmentation processor 103 segments the image into image segments.

Step 303 is followed by step 305 wherein the segment label processor 105 assigns segment labels to the image segments.

Step 305 is followed by step 307 wherein the relation processor 107 determines segment relations for the image segments.

Step 307 is followed by step 309 wherein the CRP model generator 109 generates a Constraint Reasoning Problem model having variables corresponding to the image segments and constraints reflecting the image segment relations, each variable having a domain comprising image segment labels assigned to an image segment of the variable.

Step 309 is followed by step 311 wherein the CRP processor 111 generates image labelling for the image by solving the Constraint Reasoning Problem model.

In the example, step 311 is followed by optional step 313 wherein image segments are merged in response to the image labelling.

In some embodiments, steps 301 to 313 are iterated.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. An apparatus for labelling images, the apparatus comprising:
means for segmenting an image into image segments;
assignment means for assigning segment labels to the image segments;
means for determining segment relations for the image segments;
model means for generating a Constraint Reasoning Problem model having variables corresponding to the image segments and constraints reflecting the image segment relations, each variable having a domain comprising image segment labels assigned to an image segment of the variable; and
means for generating image labelling for the image by solving the Constraint Reasoning Problem model.

2. The apparatus claimed in claim 1 wherein the image segment relations comprise spatial relations.

3. The apparatus claimed in claim 2 wherein the spatial relations comprise relative spatial relations.

4. The apparatus claimed in claim 2 wherein the spatial relations comprise absolute spatial relations.

5. The apparatus of claim 1 wherein the model means is arranged to determine the constraints in response to the segment relations and image domain data.

6. The apparatus of claim 1 wherein the assignment means is arranged to assign reliability indications for the segment labels.

7. The apparatus of claim 6 wherein the Constraint Reasoning Problem model is a fuzzy logic Constraint Reasoning Problem model.

8. The apparatus of claim 1 further comprising merging means for merging segments in response to the image labelling.

9. The apparatus of claim 8 wherein segments are merged in response to an adjacency criterion.

10. The apparatus of claim 8 wherein segments are merged in response to a segment labelling criterion.

11. The apparatus of claim 10 wherein the segment labelling criterion requires that all segments being merged have corresponding labels in all solutions of the Constraint Reasoning Problem model.

12. The apparatus of claim 1 further comprising means for selecting between solutions of the Constraint Reasoning Problem model in response to a user input.

13. The apparatus of claim 1 the apparatus is arranged to iterate a labelling of an image.

14. The apparatus of claim 1 wherein the image labelling comprises one or more solutions to the Constraint Reasoning Problem model, each solution comprising a segment label for each segment selected from the domain of the segment.

15. A method of labelling images, the method comprising:
segmenting an image into image segments;
assigning segment labels to the image segments;
determining segment relations for the image segments;
generating a Constraint Reasoning Problem model having variables corresponding to the image segments and constraints reflecting the image segment relations, each variable having a domain comprising image segment labels assigned to an image segment of the variable; and
generating image labelling for the image by solving the Constraint Reasoning Problem model.

16. The method of claim 15 wherein the steps are iterated.
